(19) United States
(12) Patent Application Publication
(10) Pub. No.: US 2011/0145689 A1
(43) Pub. Date: Jun. 16, 2011

(54) NAMED OBJECT VIEW OVER MULTIPLE FILES

(75) Inventors: John Campbell, Renton, WA (US); Lawrence Waldman, Seattle, WA (US); Daniel Parish, Kirkland, WA (US)

(73) Assignee: MICROSOFT CORPORATION, Redmond, WA (US)

(21) Appl. No.: 13/035,689

(22) Filed: Feb. 25, 2011

Related U.S. Application Data
(63) Continuation-in-part of application No. 11/223,541, filed on Sep. 9, 2005.
Application No. 11/223,541 is a continuation-in-part of application No. 11/860,394, filed on Sep. 24, 2007.

(51) Int. Cl. G06F 17/00

(52) U.S. Cl. 715/209

(57) ABSTRACT

A named object view report is generated from different electronic object sources. The object sources may be associated with different users and have different access rights. The different object sources from which the objects are obtained may be determined using a variety of methods. A user at a client is presented with the named object view report such that the user's attention is focused on the different objects that are obtained from the different object sources as if the objects were obtained from a single object source. The user may be used to cycle through the objects that are obtained from the different object sources. When an object is edited within the report by a user that is not associated with the user for editing, that object is copied to an object source that is owned by the user.

### RELATED APPLICATIONS

This application claims the benefit under 35 U.S.C. 120 of U.S. patent application Ser. No. 11/223,541 (Attorney Docket No. 14917.276US01) filed on Sep. 9, 2005 and U.S. patent application Ser. No. 11/860,394 (Attorney Docket No. 14917.708USI1) filed on Sep. 24, 2007.

### BACKGROUND

Some documents, such as spreadsheets, may include multiple sheets with each sheet including a large amount of data. A report may be generated from one or more documents to present the data in an organized format. However, the report may confuse users if the report contains too much data. A user may need to search through the report to locate desired information, which can be laborious and time consuming. Also, electronic documents typically include security at a file level thereby allowing access to the entire file or denying access to the entire file. Such security may be under inclusive and over inclusive and not represent the desired security for objects of the electronic document.

### SUMMARY

This Summary is provided to introduce a selection of concepts in a simplified form that are further described below in the Detailed Description. This Summary is not intended to identify key and/or essential features of the claimed subject matter. Also, this Summary is not intended to limit the scope of the claimed subject matter.

A named object view report is generated from different object sources (e.g. electronic data files, web pages, data feeds, memory, and other data sources). The object sources may be associated with different users and have different access rights. For example, some objects that are included within the named object view report may come from one or more spreadsheets, other objects may come from web page(s), other objects from data feed(s), and yet other objects within the report may come from other object sources. The different object sources from which the objects are obtained may be determined using a variety of methods (e.g. files accessing a same data source, a list of related files, a common data store(s), search results, and the like). A user at a client is presented with the named object view report such that the user's attention is focused on the different objects that are obtained from the different object sources as if the objects were obtained from a single object source. The user may cycle through the objects that are obtained from the different object sources. When an object is edited within the report by a user that is not associated with the user for editing, that object is copied to an object source that is owned by the user.

### BRIEF DESCRIPTION OF THE DRAWINGS

Non-limiting and non-exhaustive aspects are described with reference to the following figures.

FIG. 1 is an exemplary computer system architecture diagram illustrating a computer system;

FIG. 2 is an exemplary network architecture diagram illustrating an illustrative operating environment;

FIG. 3 is a functional block diagram illustrating the generation of a named object view report across multiple object sources;

FIG. 4 is an operational flow diagram showing aspects for generating a named object view of an electronic data report;

FIG. 5 is a functional block diagram illustrating the association of rights with the objects;

FIG. 6 is an operational flow diagram showing aspects for assigning rights to an object;

FIG. 7 is an operational flow diagram showing aspects for granting or denying rights to an object; and

FIG. 8 shows a system for creating and interacting with an NOV report across multiple object sources.

### DETAILED DESCRIPTION

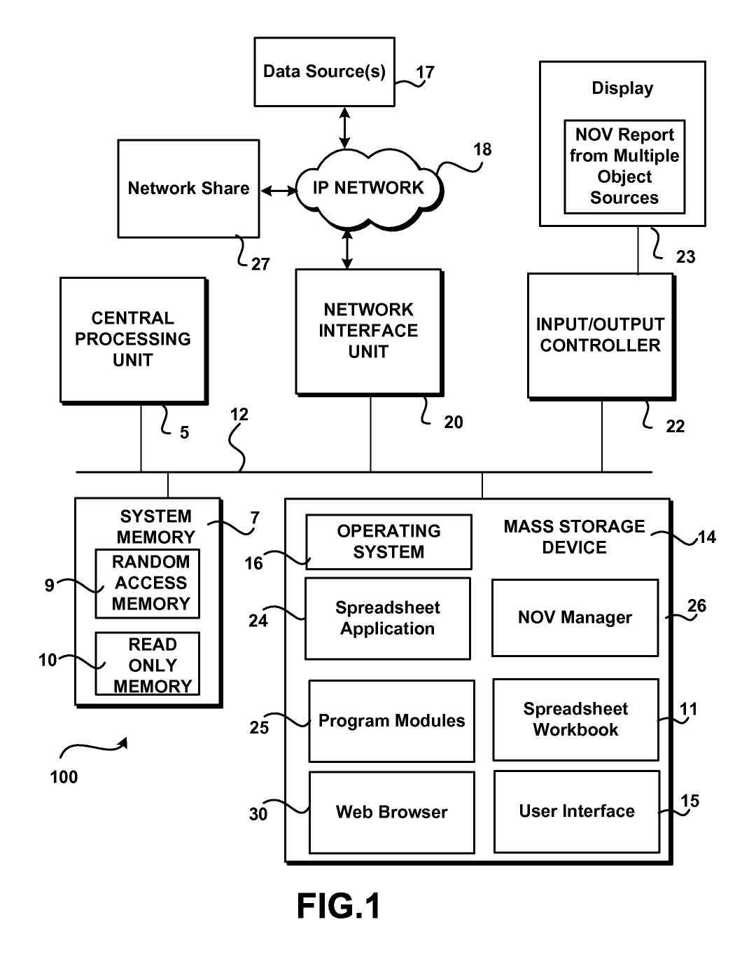

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer environment for a computer 100 utilized in the various embodiments will be described. The computer environment shown in FIG. 1 includes computing devices that each may be configured as a server, a desktop or mobile computer, or some other type of computing device and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, spreadsheet workbook 11, spreadsheet application 24, other program modules 25, web browser 30, and Named Object View (NOV) manager 26 which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

Computer 100 operates in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide input/output to an IP phone, a display screen 23, a printer, or other type of output device.

As mentioned briefly above, a number of program modules and data files may be stored in the mass storage device 14 and RAM 9 of the computer 100, including an operating system 16 suitable for controlling the operation of a computer, such as WINDOWS SERVER® or the WINDOWS 7® operating system from MICROSOFT CORPORATION of Redmond, Wash. The mass storage device 14 and RAM 9 may also store one or more program modules. In particular, the mass storage device 14 and the RAM 9 may store one or more application programs, including a spreadsheet application 24 and program modules 25. According to an embodiment, the spreadsheet application 24 is the MICROSOFT EXCEL spreadsheet application. Other spreadsheet applications may also be used. The web browser application program 30 is operative to request, receive, render, and provide interactivity with electronic documents, such as web pages that are formatted using a mark-up language (“ML”) such as HTML or XML.

As will be described in greater detail below, a named object view report may be displayed within a web page. According to an embodiment, the NOV report comprises objects that are associated with a spreadsheet application program. Although embodiments described herein are presented in the context of a spreadsheet application program other types of application programs that support electronic data reporting are contemplated. For instance, embodiments may include a word processing application program, a presentation application program, a drawing or computer-aided design application program, or a database application program in order to allow the rendering of and interaction with a document without requiring a dedicated application program.

A user interface 15 allows a user to interact with applications that are associated with computing device 100. For example, cells, tables, charts and other objects of the spreadsheet may be selected and interacted with through the user interface. According to an embodiment, spreadsheet application 24 supports a Named Object View (NOV) that displays named objects across multiple object sources. NOV manager 26 is configured to interact with one or more named objects across multiple object sources. NOV manager 26 may be located externally from spreadsheet application 24 as shown or may be a part of spreadsheet application 24. Further, all/some of the functionality provided by NOV manager 26 may be located internally/externally from spreadsheet application 24.

NOV manager 26 is configured to generate a named object view report from different electronic object sources. The object sources may be located in one or more locations. For example, the object sources may be stored on mass storage device 14, network share 27, and the like. Objects may use data from a common data source, such as one of the data source(s) 17. For example, different objects in different object sources may use the same data source to create different objects (e.g. charts, tables). The object sources used to select the objects to publish in the report may be associated with the same/different users and have different access rights. Some objects that are included within the NOV report may come from one spreadsheet workbook, other objects may come from another spreadsheet workbook, and yet other objects within the report may come from other object sources. For example, objects may be obtained from a web page (e.g. HTML, XML), a data feed (e.g. a Rich Site Summary (RSS) feed or some other feed), and the like. The web page may include static content as well as changing content (i.e. a chart that changes). The different object sources from which the objects are obtained may be determined using a variety of methods. For example, NOV manager 26 may determine the objects across multiple object sources that are using data from a same data source. The object sources may be all/portion of the object sources within a data store. The object sources may be a list of recently used object sources, a list of user-defined object sources, a list of related object sources (e.g. documents of a certain type, documents in a certain folder), objects stored in a memory, web pages, data feeds, and the like. The objects may be obtained from a search for one or more objects. For example, the data returned from a search may be used to locate objects that are used to create the NOV report.

Display 23 may be used to display the NOV report that is obtained across multiple object sources. The NOV report is displayed as if the objects were obtained from a single file. In other words, the user does not have to access different object sources in order to see the objects that are obtained from the different object sources. User interface 15 may be used to interact with the objects that are obtained from the different object sources and displayed. For example, a user may display and edit the different objects within the NOV report. Some of these objects may already be associated with a user (e.g. read/write permission), whereas other objects within the report may not be associated with the user (e.g. an object that is obtained from a file belonging to another user). According to an embodiment, when an object is edited that is not associated with the user for editing, that object is copied to a file that is owned by the user. According to an embodiment, a new sheet of a workbook is created to store the copy of the object. Additional details regarding the process for generating a named object view of a report from multiple object sources are provided below.

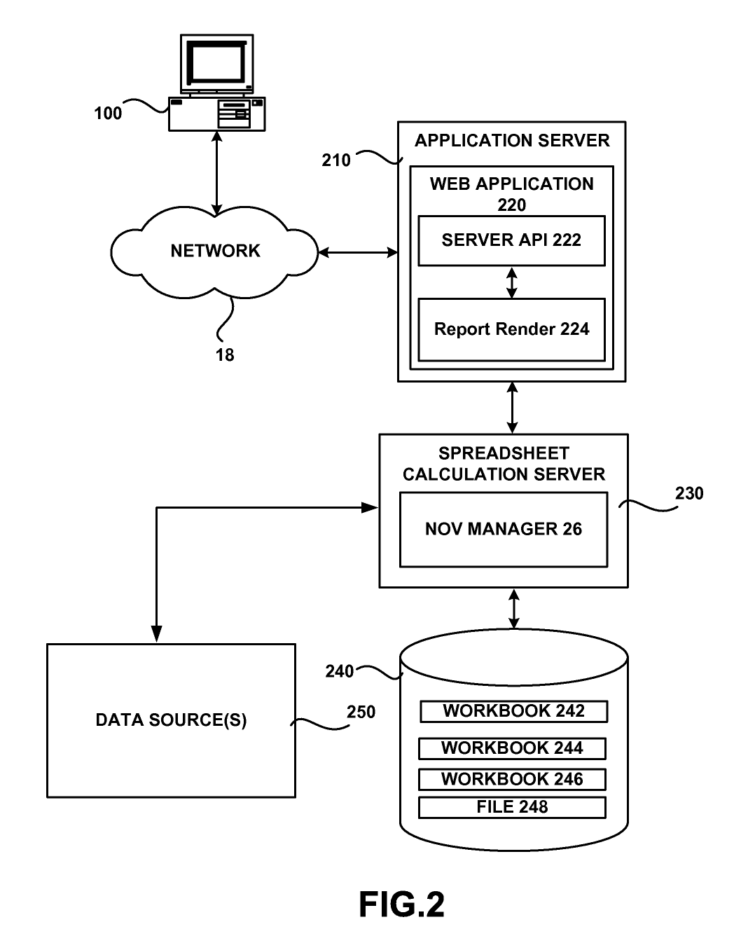

As shown in FIG. 2, the computer 100 is connected to the network 150. Also connected to the network 150 is an application server 210. The application server 210 comprises a server computer which may contain some or all of the conventional computing components described above with respect to FIG. 1. Additionally, the application server 210 is operative to execute a web server application for receiving and responding to requests for files/documents/data sources stored at or accessible to the application server 210. Moreover, the application server 210 is operative to receive and respond to requests for pages generated by a web application 220. Web application 220 may comprise code executable at the application server 210, executable code for communicating with other computers, and may include templates, graphics, audio files, and other content.

The web application 220 is operative to provide an interface to a user of the computer 100 to view a named object view of a report associated with electronic data accessible via the network 150. In particular, the web application 220 utilizes a server application programming interface (“API”) 222. The server API 222 may be operative to enable communication with a spreadsheet calculation server 230. The spreadsheet calculation server 230 is operative to execute NOV manager 26. NOV manager 26 comprises an executable program for retrieving and calculating a named object view of a report associated with electronic data. The electronic data may come from one or more different object sources and may be any type of object source, such as one or more workbooks (e.g. workbook 242, workbook 244 and workbook 246, file 248) stored in a data store 240 and/or data from data source(s) 250. The spreadsheet calculation server 230 may include many of the conventional hardware and software components discussed above with respect to FIG. 1.

The computer 100 may transmit a request to the application server 210 for a named object view of a report that spans multiple object sources (e.g. workbooks 242, 244, 246 and file 248 and/or data from data source 250) within the context of the web browser application 144. In response to such a request, the web application 220 communicates with the spreadsheet calculation server 230 through the server API 222. In particular, the web application 220 requests from the spreadsheet calculation server 230 the requested named object view of the report.

The spreadsheet calculation server program 232 loads the appropriate data from sources (e.g. workbook 242, workbook 244, workbook 246, file 248 from the data store 240 and data source 250) and processes the obtained data to locate the objects to publish in the report. The object sources are processed as discussed in detail below. Briefly, the spreadsheet calculation server 230 identifies the objects to be published across the multiple object sources. The spreadsheet calculation server 230 generates the named object view of the report associated with the object sources by publishing the identified objects. The report renderer 224 converts the published objects into ML such that each object that is identified for publishing may be individually rendered by the web application 220. The application server 210 forwards the ML version of the published objects to the client 100 for display by a web browser via the network 150. A user at the client 100 may then view the published objects that are obtained from the multiple object sources.

In another aspect, an author and/or administrator of a file (e.g. workbook 242) may set rights associated with the objects within the file. The rights may include an access right, a no access right, a write access right, a read access right, an edit access right and/or any other type of right or security for securing objects. The user rights may be associated with a specific user identifier and/or a group identifier associated with a plurality of users. In one aspect, the user identifier and/or group identifier is an identifier associated with a document management server or user management server. In this manner, an author and/or administrator may easily set rights for objects of one or more of the files below the file level. In one aspect, the rights are associated with the objects generated from the data of a workbook. The data of the object sources may include a different set of rights that are separate from the rights of the objects generated from the data. The data of object sources may include no access rights for any user/user except for the author. The objects generated from the data of the object sources may include a combination of access rights depending of the rights granted to a particular user. As an example, an author/administrator may grant no rights to the data of some object sources and grant an access right to a pivot table object, generated from the data in an object source, to a first user and grant no access rights to a chart object, generated from the data in the same object source/another object source, to the first user.

Continuing with the above example, the computer 100 may transmit a request to the application server 210 for a named object view of a report across multiple object sources within the context of the web browser application 144. The request may include an associated user identifier and/or group identifier. In response to such a request, the web application 220 communicates with the spreadsheet calculation server 230 through the server API 222. In particular, the web application 220 requests from the spreadsheet calculation server 230 the requested named object view of the report that spans the multiple object sources.

The spreadsheet calculation server program 232 loads the appropriate object sources from the data store 240 and processes the object sources (e.g. workbooks/files) and loads any other data/files from one or more other object sources, such as data source 250. The spreadsheet calculation server 230 identifies the objects to be published across the object sources. The spreadsheet calculation server 230 generates the named object view of the report associated with the object sources by generating the named object view based on the object sources.

The report renderer 224 determines whether the objects include security rights. The security rights are identified by a user identifier and/or group identifier associated with the objects of the object sources. The user identifier and/or group identifier associated with the request is compared to the security rights of the objects to determine whether to grant access. When the requesting user has access rights to the object, the report renderer 224 converts the published objects into ML such that each object that is identified for publishing and has the appropriate rights for the requesting user may be individually rendered by the web application 220. The application server 210 forwards the ML version of the published objects to the client 100 for display by a web browser via the network 150. A user at the client 100 may then view and edit/interact with the accessible published objects of the object sources.

In other aspects, a user at client 100 may associate a link to the object, such as a resource identifier, in another client application that has a hosted web render. The client application may be an application apart from a web browser. The object renders in the client applicant and the user may interact with the object. Such interaction may include manipulating the object, changing fields of the object and other types of interaction that is typically association with a spreadsheet application. When interacting, the ML associated with the object is refreshed on the client application by a session identifier and communication between the hosted web render of the client application and application server 210. In this manner, the user may interact with the object in a client application to provide “live” features through ML refresh on the client application.

Continuing with the above example, an author/administrator may grant no rights to the data of an object sources and grant an access right to a pivot table object to a first user and grant no access rights to a chart object to the first user. When the first user sends a request for objects associated with the multiple object sources, an identifier of the first user is compared to the objects. In the above example, the first user has no access to the data of the object sources, the user has no access to the chart object, and the user has access to the pivot table object. In this manner, an author/administrator may publish objects of the object sources and tailor access rights to the objects according to the requesting user of the objects. The first user may associate the resource identifier of the pivot table object with a slide presentation application. The ML of the pivot table object is association with the slide presentation application. The user may, for example, pivot the pivot table object. The ML associated with the pivot table object is refreshed on the client application by a session identifier and communication between the hosted web render of the client application and application server 210. In one aspect, the rendering of the pivot table is pulled down from the server and is interactive but the data associated with the pivot table (e.g. any internal cashes, the data in the spread sheet, etc.) remains on the server and is not sent between the client and the server. In this manner, the user may interact with the pivot table object in the slide presentation object to provide “live” features through ML refresh on the client application.

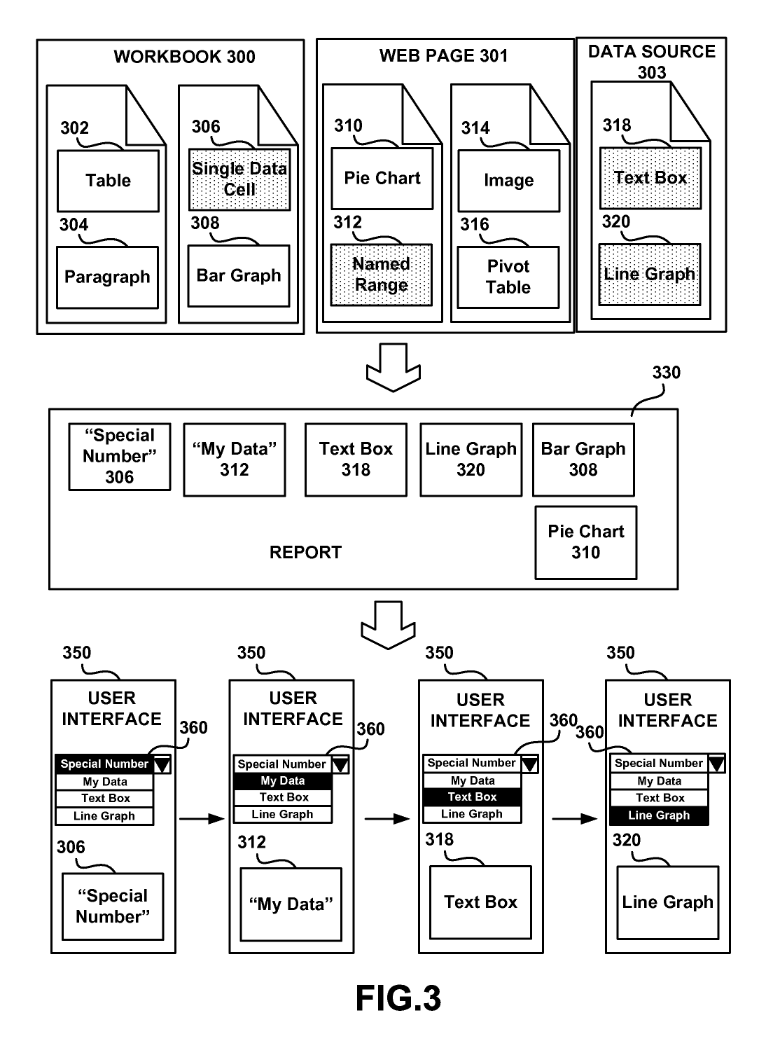

FIG. 3 is a functional block diagram illustrating the generation of a named object view report across multiple object sources. The named object view of the report is generated from different electronic object sources. As shown in the diagram, the electronic data object sources are obtained from a workbook, such as workbook 300, a web page 301 and from data source 303. The electronic object sources, however, may be any file/data source that may be associated with an object. For example, one or more objects that are created from a common data source may be displayed within the named object view. The object may or may not be stored within an object source when it is obtained and displayed within a report. For example, the object may be a newly created object that is not yet stored within a electronic file, but is stored within a memory of a computing device.

Workbooks may include multiple objects on different pages. The objects may be any item in the workbooks that can be individually selected or manipulated. For example, the objects in workbook 300 may include a table 302, a paragraph 304, a single data cell 306 and a bar graph 308. Other objects may also be included within workbook 300. As illustrated, web page 301 includes a pie chart 310, a named range 312, an image 314, and a pivot table 316. Data source 303 includes a text box 318, and a line graph 320. Some of the objects may use data from a common data source. For example, bar graph 308 in workbook 300, pie chart 310 in web page 301, and line graph 320 from data source 303 may be created from the same data source. In one embodiment, an object may be defined to encompass multiple smaller objects. For example, an object may correspond to multiple pages of a workbook. In another embodiment, an object may include dynamic information such that the size of the object changes over time. For example, the named range 312 may correspond to a range of cells that are contained within a workbook (e.g. workbook 300 and/or some other workbook (not shown)). The range of cells may increase or decrease in size in response to spreadsheet processing. The named range may correspond to a range from other data sources. For example, a web page may contain a range of values that change over time.

The report may be generated automatically in response to an event (e.g. a user opening a workbook, selecting a NOV option within a user interface, performing a search, and the like). For example, an author user or administrative user may access one or more of the workbook, web page, and/or a data source from a server to generate a report 330. Alternatively, a workbook, web page, and/or a data source may be accessed at a client. The objects to publish in the report may be automatically/manually selected. For example, the user may select all/portion of the objects to publish in the report. For example, the user may manually select the single data cell 306 in workbook 300, the named range 312 in web page 301 and the text box 318 and the line graph 320 in data source 303 to appear in the report 330. Bar graph 308 and pie chart 310 may be automatically selected to be published as they are created using common data (e.g. the same data source). The user may open a file/workbook from a publisher interface. In one embodiment, names associated with the objects are provided in the publisher interface. The user may select the objects to publish from the list. In one embodiment, objects may be selected for publication from multiple workbooks.

Each object to be published is associated with a unique name. The user may select the objects for inclusion in the report 330 by name such that each published object may be easily identified. In one embodiment, the published object names may be automatically generated. For example, the table 302 may be automatically identified as “table”, “table1”, or some other unique name. The user may rename the automatically generated name. In another embodiment, the user defines a name for the published object. For example, the single cell data 306 may be defined as “special number”. Likewise, the named range 312 may be defined as “my data”.

The selected objects are published in the report 330. For example, the single data cell (“special number”) 306, the named range (“my data”) 312, the text box 318, and the line graph 320 are published in the report 330. The unselected portions of the workbook 300, web page 301 and data source 303 are not published in the report 330.

According to an embodiment, the object sources that utilize a same data source are searched to determine the objects to obtain from the object sources. For example, many object sources may create objects (e.g. tables, charts, graphs) using the same data source. In the current example, the bar graph 308 and pie chart 310 are created using the same data. A user may desire to see all of the objects created using the data source. The data source may be automatically/manually selected. For example, the data source(s) may be determined from the selected object(s) and/or the data source may be determined from input from a user (e.g. through a user interface element). The user may then select a NOV mode the user may view the selected objects by cycling through different views that are obtained from the data source.

Another example includes where users may view a web page and alter the data, creating unique and interesting views specific to their interpretation of the data. The users may want to share those views, especially in today's socially connected internet environment. In this example, assume that a user has friends who each have made multiple views using the data from the web page. Each of these friends may have one or more object sources (e.g. files) that are used to store the different views. One or more of the views may also be stored in a memory. When a report is generated to show a view created from the web page, the different object sources that include the views created by the different users may also be searched for the similar objects. The objects from the different object sources are obtained and are included in the report. When cycling through the various views of the objects, a user may see all of the different views without having to individually access each object source.

According to an embodiment, the permissions of the object sources are followed. For example, views that the user does not have access are not shown, but views the user does have access are displayed.

A user at the client is presented with a named object view of the report 330. According to an embodiment, the report does not distinguish where an object is obtained from. According to another embodiment, a user may query the object to determine where it is located. For example, a user may right click on a displayed object to find out its location and/or open the object and the associated object source from where it was obtained.

A report renderer converts the published objects into ML when requested. For example, one of the object sources (e.g. workbook 300) is accessed from a server. The ML version of the published objects is forwarded to a client for display via a web browser. In one embodiment, a published object is rendered on a user interface 350. For example, the user interface 350 may be a web part. A web part is a modular unit of information that has a single purpose. Web parts form the basic building blocks of many web pages. More than one web part may be simultaneously displayed on a dashboard at the client such that different published objects may be viewed side-by-side. For example, the user may select the text box 318 and the line graph 320 for display on different web parts because the text box 318 elaborates on data presented in the line graph 320.

A tool bar that includes the names of the published objects may also be rendered on the user interface 350. The tool bar may be used for accessing specific published objects. For example, the tool bar is a drop down menu 360 that includes a list of the names of the published objects. Specifically, the drop down menu 360 includes selectable entries for “special number”, “my data”, text box, and line graph. The other objects may also be included within the user interface. The named object view of the report is rendered on the user interface 350 with the first published object (i.e., “special number”). The other published objects may be rendered at the user interface 350 in response to user input. For example, the user may select an entry from the drop down menu 360 such that the user interface 350 refreshes and the published object corresponding to the selected entry is rendered on the user interface 350. Thus, each published object may be individually displayed to the user at the client. The named object view of the report focuses the user's attention on the published objects. The non-published objects of the object sources are not displayed to the user.

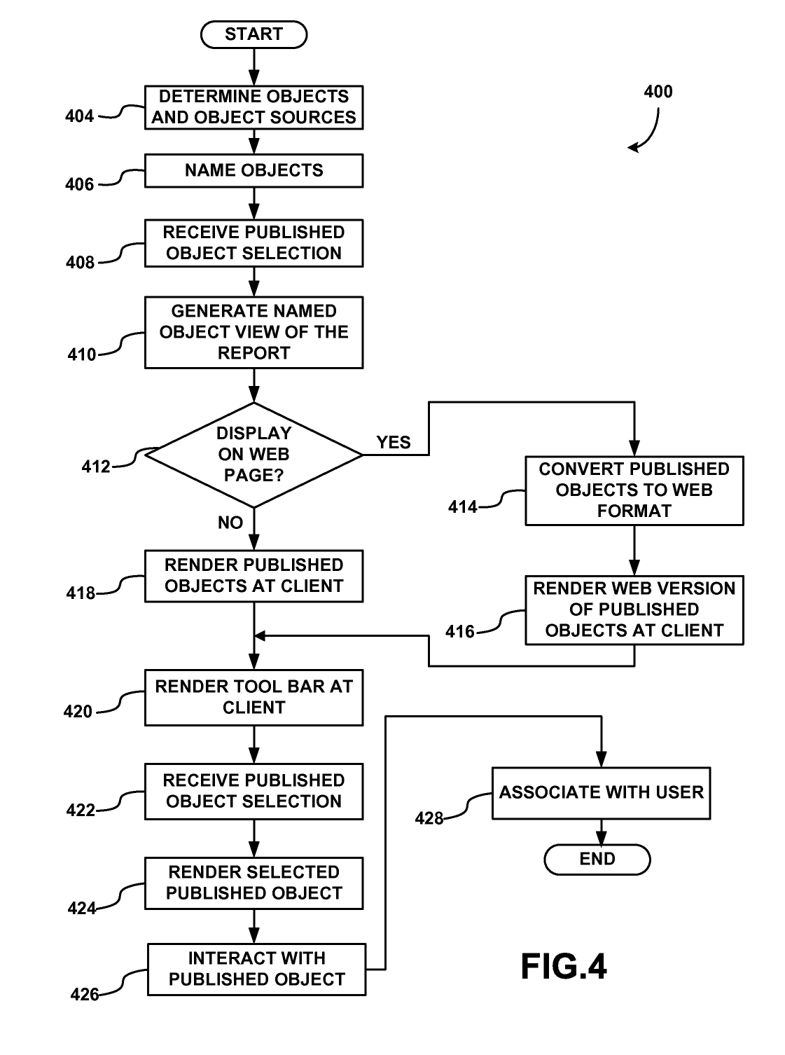

FIG. 4 is an operational flow diagram showing aspects of generating a named object view of a report associated with electronic data. Operational flow 400 begins at a start operation. An NOV report including objects from the object sources is created by a user and rendered at a client as discussed in detail below.

The objects are determined and the object sources are accessed/opened at block 404. The object sources may include multiple objects. The objects may be any item in the object source that can be individually selected or manipulated. The objects may be associated with static or dynamic information. Objects within the different object sources may be associated with one another. For example, an object from a first object source may be a different view of an object within a second object source. The object may also be a similar object to another. For example, a search may be performed that returns a number of different objects from different object source (e.g. a search for chart objects may return a number of objects from a number of different object sources). A user may also enter one or more search terms to search for objects within a group of object sources (e.g. 2010 budget, offices, co-workers, and the like). Objects within the different object sources may be created from a common data source. For example, the same data source may be used to create many different views/objects (e.g. charts and graphs using sales data).

Moving to operation 406, the objects in the object sources are named. In one embodiment, an object is automatically assigned a name. For example, two images may be assigned the names “image1” and “image2” respectively. In another embodiment, the name of an object is user-defined. For example, a single cell or a named range in a spreadsheet file may be defined with a name that communicates meaning to the user. The name of any object may also be renamed by the user.

Transitioning to operation 408, a selection of objects to publish in the report may be received. According to an embodiment, the user selects the objects to publish from a list of the named objects. In another embodiment, the user may navigate the object source and select each object to be published directly from the object source. In yet another embodiment, the user may select the objects to publish from multiple object sources. The objects may also be automatically selected. For example, all/portion of the objects within the object sources may be automatically selected for inclusion within the report.

Proceeding to operation 410, the named object view of the report is generated using the published objects that are obtained from the different object sources. Any objects in the object source that are not selected for publication are not included in the report.

Continuing to decision operation 410, a determination is made whether the named object view of the report is to be displayed on a web page. The named object view of the report is displayed on a web page when the object source is retrieved from the data store via a server, in which case processing proceeds to operation 414. The named object view of the report is not displayed on a web page when the object source is retrieved from the data store at the client, in which case processing proceeds at operation 418.

Continuing to operation 414, a report renderer converts the published objects to a format suitable for display (e.g. on a web page). For example, the report renderer may convert the published objects to ML. Advancing to operation 416, the web-formatted version of the published objects is rendered at the client for display by a web browser. A user at the client is presented with a named object view of the report. In one embodiment, the first published object is rendered on a web part. The user may navigate to the other published objects such that one published object at a time is rendered in the web part.

Proceeding to operation 418, the published objects are directly rendered at the client. A user at the client is presented with a named object view of the report. In one embodiment, the first published object is rendered in a user interface at the client. The user may navigate to the other published objects such that one published object at a time is rendered in the user interface.

Moving to operation 420, a tool bar is rendered at the client. The tool bar includes the names of the published objects such that the user may navigate to specific published objects. In one embodiment, the tool bar is a drop down menu of a list of the names of the published objects. The drop down menu is rendered in the web part or the user interface.

Transitioning to operation 422, a particular published object selection is received at the tool bar from the user. For example, the user may select a published object from the drop down menu.

Proceeding to operation 424, the selected published object is rendered at the client. For example, the web part or the user interface refreshes in response to the user input such that the selected published object is displayed on the web part or the user interface. Thus, the user's attention is focused on the published objects in the report. The unpublished file data is not presented to the user and may be disregarded.

Flowing to operation 426, an object within the NOV report may be interacted with. For example, the user may view the object, move the object, edit the object, and the like. When the object is to be edited a determination is made as to whether or not the user performing the edit “owns” the object (e.g. has write permission). In some cases, the object may be obtained from an object source from which the user does not have write access and/or the user desires to have a copy of the object to perform their own operations on. When the user does not own the object, the object being edited is associated with the user at operation 428. According to an embodiment, a copy of the object is made and stored in an object source that is owned by the user such that changes made to the object by one user do not adversely impact another user. Processing then terminates at end operation.

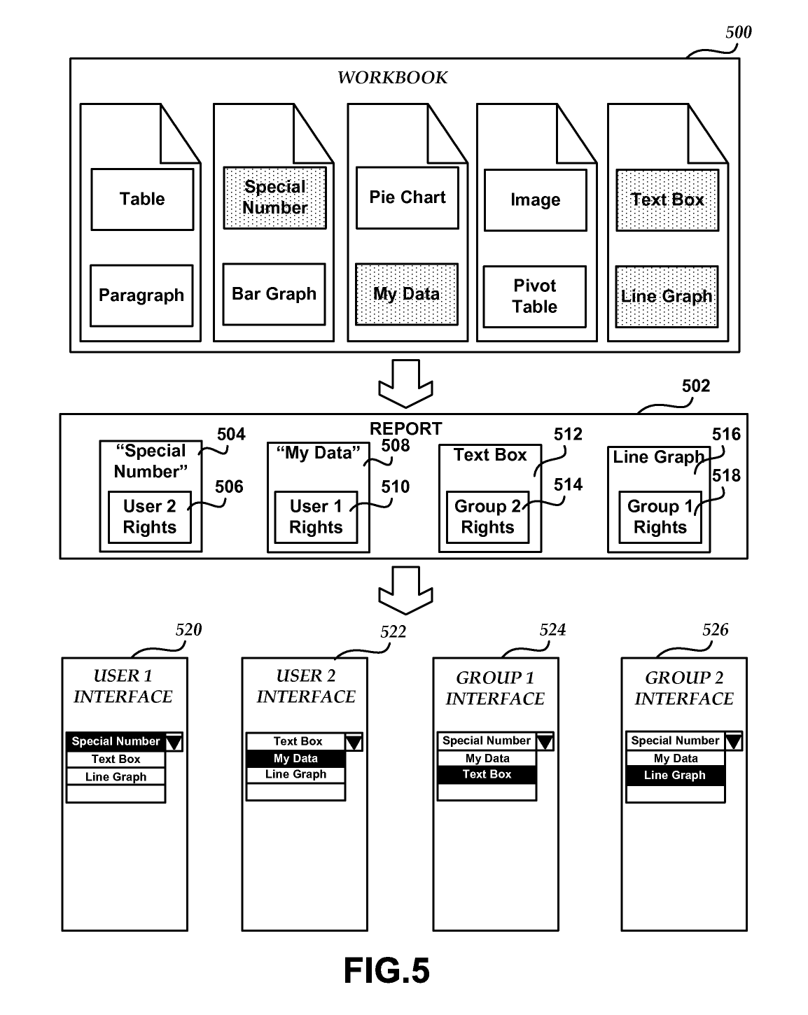

FIG. 5 is a functional block diagram illustrating the association of rights with objects in an object source. Rights may be associated with objects in one or more of the object sources used in generating the named object view report. As shown in the diagram, the electronic object source is a workbook 500 associated with a spreadsheet application. However, the electronic object sources may be any object source that may be associated with a report.

Workbook 500 includes multiple objects on different pages. Workbook 500 may also include rights associated with the objects as depicted in report 502. An author user or administrative user may access the workbook 500 from a server to generate a report 502. Alternatively, the workbook 500 may be accessed at a client. The user selects objects to publish in the report. The user may also associate rights with the objects. For example, as depicted in report 502, special number object 504 includes user 2 rights 506, my data object 508 includes user 1 rights 510, text box object 512 includes group 2 rights 514, and line graph object 516 includes group 1 rights 518. In this example, the rights are exclusive; however, the rights may also be inclusive rights and/or any other combination of rights to protect access to the objects.

The selected objects are published in the report 502 according to their respective rights. A user at the client is presented with a named object view of the report 502. A report renderer converts the published objects into ML when the workbook 500 is accessed from a server. The ML version of the published objects is forwarded to a client for display via a web browser according to the respective rights of the user. A tool bar that includes the names of the published objects may also be rendered on the user interfaces 520, 522, 524 and 526 according to the respective rights. The tool bar may be used for accessing specific published objects according to the rights. In the example associated with FIG. 5, the rights are exclusive. Accordingly, user 1 interface 520 does not have access to my data object 508 because user 1 rights 510 exclude such access, user two interface 522 does not have access to special number object 504 because user 2 rights 506 exclude such access, group 1 interface 524 does not have access to line graph object 516 because group 1 rights 518 excludes such access, and group 2 interface 526 does not have access to text box object 512 because group 2 rights 514 exclude such access. The rights may include any combination of exclusive and inclusive rights and are not limited by the example in FIG. 5.

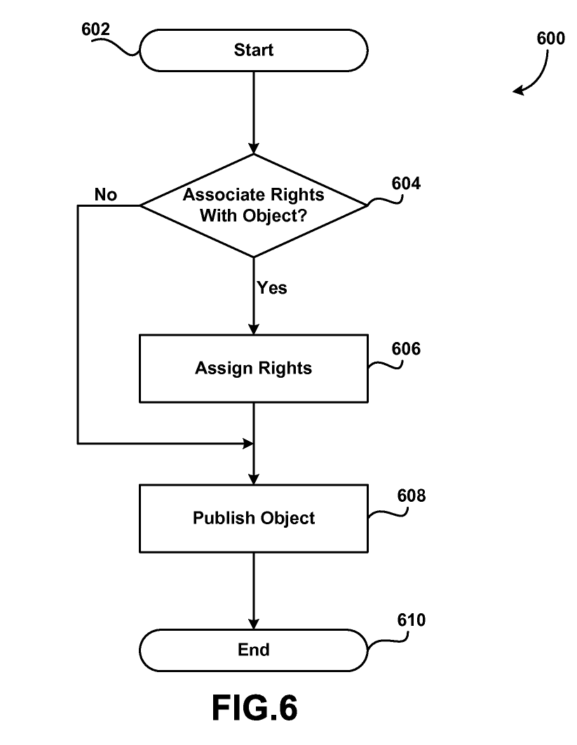

FIG. 6 is an operational flow diagram showing aspects of an illustrative process for assigning rights to an object. Operational flow 600 begins at start operation 602 and continues to decision operation 604 where a determination is made on whether to associate rights with an object. Rights may be automatically associated with an object or rights may be author determined Different right may be associated with different objects of the same object source.

If it is decided that rights are not to be associated with an object, operational flow 600 continues to operation 608. If it is decided that rights are to be assigned to an object, operational flow 600 continues to operation 606 where rights are associated with the object. As indicated above, the rights may be exclusive rights, inclusive rights or any other type of rights for protecting access to an object. In one aspect, the rights are indicated by an access level that is associated with a user identifier and/or a group identifier.

Operational flow 600 continues to operation 608 where the objects are published according to their respective security rights. Operational flow 600 ends at end operation 610.

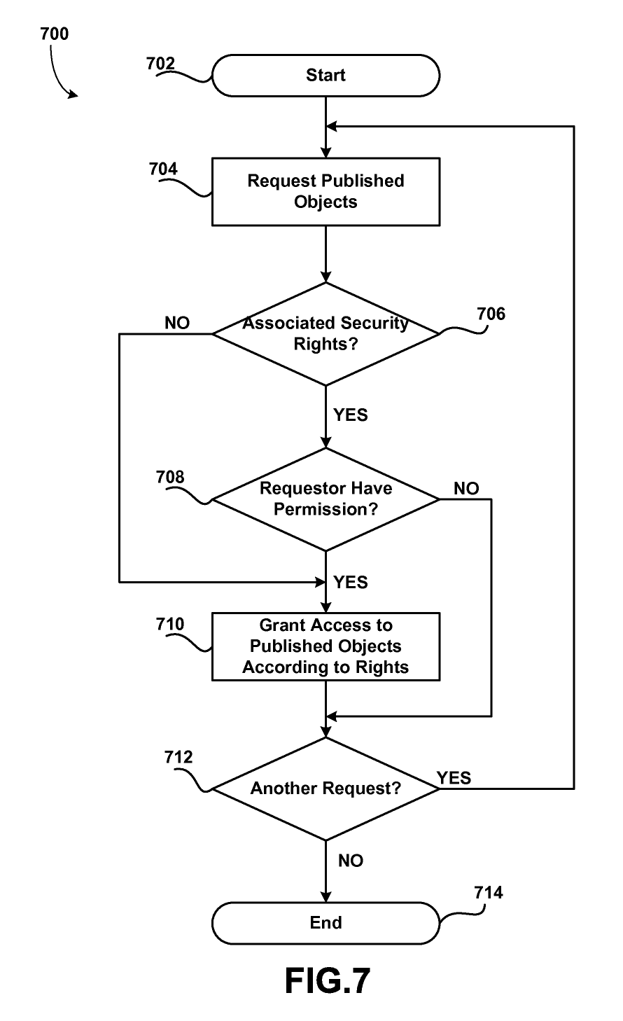

FIG. 7 is an operational flow diagram for granting or denying rights to an object. Operational flow 700 begins at start operation 702 and continues to operation 704 where a request for published objects is received. The request may be received from a client. In one aspect, the request includes a user identifier, a group identifier or any other type of identifier that identifies a user that is attempting to access the published objects.

Operational flow 700 continues to decision operation 706 where it is determined whether the requested published objects have associated security rights. If not, operational flow 700 continues to operation 710 as discussed below. If requested published objects have associated security rights, operational flow 700 continues to decision operation 708.

At decision operation 708, it is decided whether the requestor has rights to the objects. In one aspect, a user or group identifier of the requesting user is compared to an identifier and permissions associated with the object. For example, the object may include a user identifier and a right associated with the user identifier. When a user identifier is received with the request and matches the user identifier associated with the object, the user is granted or denied access according to the right associated with the object. If the requestor does not have permission to access the object, operational flow 700 continues from decision operation 708 to operation 712 as discussed below. If the requestor has permission to access the object, operational flow 700 continues to operation 710 where access is granted to the object.

Once access is either granted or denied, operational flow 700 continues to decision operation 712 where it is determined if another request has been received. If so, operational flow 700 loops back to operation 704. If not, operational flow 700 continues to end operation 714.

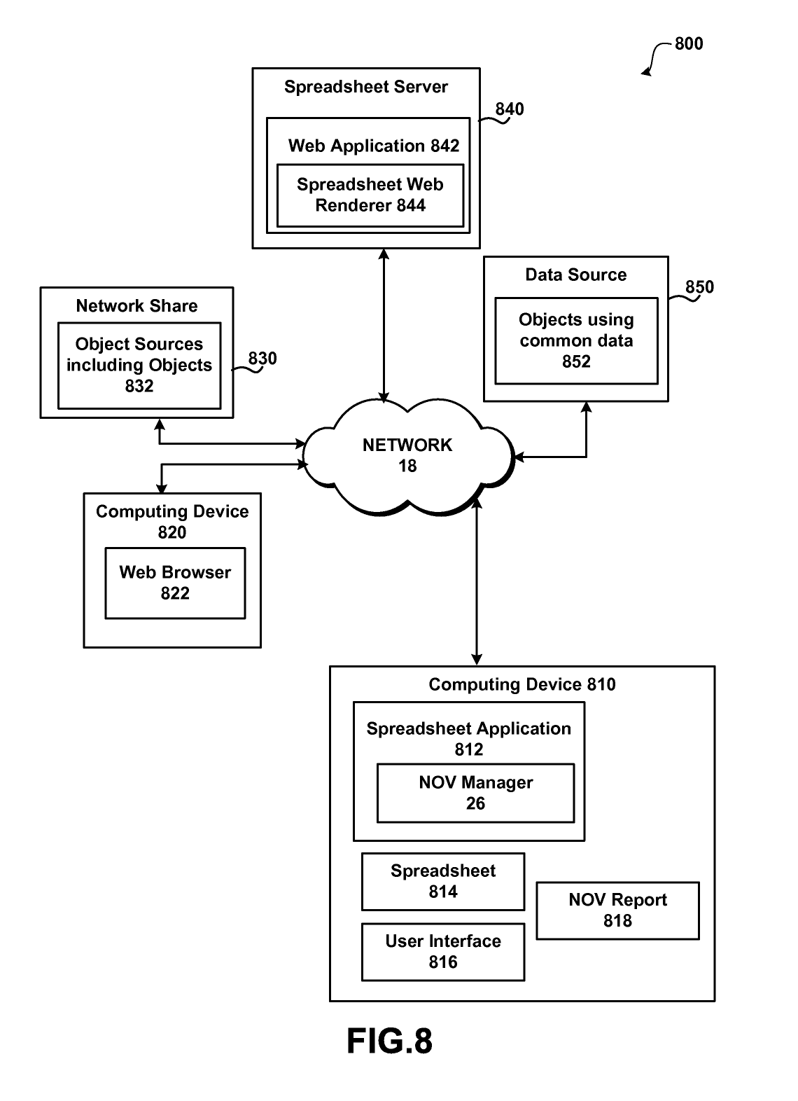

FIG. 8 shows a system for creating and interacting with an NOV report across multiple object sources. As illustrated, system 800 includes computing device 810, computing device 820, network share 830, spreadsheet server 840 and data source 850.

The computing devices may be any type of computing device that is configured to perform the operations relating to interacting with spreadsheet objects. For example, some of the computing devices may be: mobile computing devices (e.g. cellular phones, tablets, smart phones, laptops, and the like); desktop computing devices and servers. Some computing devices may be arranged to provide an online cloud based service (e.g. interacting with spreadsheets and spreadsheet objects online), some may be arranged as data shares, some may be arranged in local networks, some may be arranged in networks accessible through the Internet, and the like.

The computing devices are coupled through network 18. Network 18 may be many different types of networks. For example, network 18 may be an IP network, a carrier network for cellular communications, and the like. Generally, network 18 is used to transmit data between computing devices, such as computing device 810, computing device 820, network share 830, spreadsheet server 840 and data source 850.

Computing device 810 includes spreadsheet application 812, spreadsheet 814 and user interface 816. As illustrated, computing device 810 is used by a user to interact with an NOV report that comprises objects selected to be published from multiple object sources.

Spreadsheet 814 comprises different cells/spreadsheet objects that may be interacted with using spreadsheet application 812. The spreadsheet may contain many different kinds of data or objects. For example, cells, tables, charts and other objects may be included within the spreadsheet.

User interface (UI) 816 is used to interact with a spreadsheet, such as spreadsheet 814 and spreadsheet objects that are displayed in an NOV report created from multiple object sources. One or more user interfaces of one or more types may be used to interact with the spreadsheet. For example, UI 816 may be a context menu, a menu within a menu bar, a menu item selected from a ribbon user interface, a graphical menu, and the like. Generally, UI 816 is configured such that a user may easily interact with the spreadsheet and spreadsheet objects, including the spreadsheet objects included within an NOV report. For example, when an object is selected within NOV report 818 using user interface 816, one or more options may be presented to the user to interact with the selected published object and/or to perform an action relating to the object. The options that are associated with a published object may include many different types of items and actions that include, but are not limited to: changing a view of the object, editing data that is associated with the object, locating an object, saving the object, and the like. For example, a user may simply select an option within UI 816 that opens up the file that is storing the currently viewed object.

A network share 830 may be used to store information relating to one or more object sources (e.g. spreadsheets/files). Network share 830 is accessible by the computing devices that interact with a spreadsheet 832 and/or spreadsheet objects. The network share may be associated with an online service that supports online access/interaction with the spreadsheet and spreadsheet objects. For example, spreadsheet server 840 may be configured as an online service to provide online users with the ability to interact/modify spreadsheets that include spreadsheet objects.

A data source 850 may be used in the creation of one or more objects. The same/different user may use data source 850 to create different views of the same data. For example, one user may create a chart using data from data source 850, whereas another user may create a graph using some/all of the data used to create the chart. Objects using common data (objects 852) may be identified such that they may be located more efficiently. For example, a list of objects using common data may be stored within a memory/data store.

Computing device 820 includes one or more applications, such as web browser 822 that may be configured to view/enter/interact with data/objects that are associated with a spreadsheet. For example, web browser 822 may be used to access spreadsheet server 240 to interact with an NOV report.

Spreadsheet server 840 includes web application 842 that comprises spreadsheet web renderer 844. According to an embodiment, spreadsheet server 840 is configured as a server that is located within an online service that is configured to provide services relating to displaying an interacting with spreadsheets. Web application 842 is configured for receiving and responding to requests relating to spreadsheet documents. For example, spreadsheet server 840 may access object sources on network share 830 to create an NOV report. Web application 842 is operative to provide an interface to a user of a computing device, such as computing device 820, to interact with a spreadsheet accessible via network 18. Web application 842 may communicate with a spreadsheet calculation server that is used for retrieving and calculating spreadsheets, such as the spreadsheet 832 stored at network share 830. The calculation server is configured to interact with and process operations relating to spreadsheet objects.

Spreadsheet server 840 receives requests from computing devices, such as computing device 820. A computing device may transmit a request to spreadsheet server 840 to perform an action relating to an object, such as viewing the spreadsheet that includes an object. In response to such a request, the web application 842 obtains the spreadsheet from a location, such as network share 830. The spreadsheet to display is converted into a markup language format, such as the ISO/IEC 29500 format. The spreadsheet may be converted by spreadsheet server 840 or by one or more other computing devices. Once the web application 842 has received the markup language representation of the spreadsheet, the spreadsheet server utilizes the spreadsheet web renderer 844 to convert the markup language formatted spreadsheet into a representation of the spreadsheet that may be rendered by a web browser application, such as web browser 822 on computing device 820. The rendered spreadsheet appears substantially similar to the output of the spreadsheet application 812 on computing device 810 when utilized to view the same spreadsheet. Once the spreadsheet web renderer 844 has completed rendering the file, it is returned by the spreadsheet server 840 to the requesting computing device, such as computing device 820, where it may be rendered by the web browser 822. The web renderer 844 may also be configured to display the objects that are contained within an NOV report that is created from multiple object sources.

The spreadsheet web renderer 844 is also configured to render into the markup language file one or more scripts for allowing the user of a computing device, such as computing device 820 to interact with the spreadsheet objects that are contained within the NOV report within the context of the web browser 822. Spreadsheet web renderer 844 is operative to render script code that is executable by the web browser application 822 into the returned web page. The scripts may provide functionality, for instance, for allowing a user to change a view of the object and/or to modify values that are related to the object. In response to certain types of user input, the scripts may be executed. When a script is executed, a response may be transmitted to the spreadsheet server 840 indicating a spreadsheet object within the spreadsheet that has been acted upon, to identify the type of interaction that was made, and to further identify to the web application 842 the function that should be performed upon the appropriate spreadsheet object.

Based on the foregoing, it should be appreciated that the various embodiments include a method, system, apparatus, and computer-readable medium for generating a named object view of a report associated with electronic data. The above specification, examples and data provide a complete description of the manufacture and use of the composition.

What is claimed is:

1. A method for generating a named object view report from multiple object sources, comprising;
determining different object sources to access that are used in generating a named object view (NOV) report;
identifying within the different object sources, objects for publication to the NOV report;
excluding objects from publication in the NOV report that are not identified from the different object sources;
determining names for the identified objects for publication;
generating the NOV report comprising the identified objects for publication; and
rendering the NOV report.

2. The method of claim 1, wherein identifying within the different object sources objects for publication within the NOV report comprises automatically identifying the objects for publication based on the objects within the different object sources.

3. The method of claim 1, wherein determining the different object sources to access that are used in generating the NOV report comprises determining object sources that are returned as a result of a search of objects.

4. The method of claim 1, wherein determining the different object sources to access that are used in generating the NOV report comprises determining a list of recently accessed object sources.

5. The method of claim 1, wherein determining the different object sources to access that are used in generating the NOV report comprises determining object sources that include a same type of object.

6. The method of claim 1, further comprising determining when an object within the rendered NOV report is edited and associating the object with a user editing the object.

7. The method of claim 6, wherein associating the object with the user editing the object comprises creating a copy of the object and storing the copy of the object in an object source that is associated with the user editing the object.

8. The method of claim 1, wherein identifying within the different object sources objects for publication to the NOV report comprises determining an access right for each of the different object sources and the objects and excluding objects for publication based on the access right, wherein the access right is at least one member of a group comprising: a view access right, a no access right, a read access right, a write access right, and an edit access right.

9. The method of claim 1, wherein a spreadsheet file is associated with each of the identified objects to publish that is not stored within an existing spreadsheet file.

10. A computer-readable storage medium having computer-executable instructions stored thereon that when executed by a computer generate a named object view report from multiple object sources, the instructions comprising;
receiving a request to generate a named object view (NOV) report;
determining different object sources to access that are used in generating the NOV report, wherein the different object sources comprise spreadsheet objects;
identifying within the different object sources objects for publication to the NOV report;
excluding objects from publication in the NOV report that are not identified from the different object sources;
generating the NOV report comprising the identified objects for publication; and
rendering the NOV report such that the identified objects for publication are editable.

11. The computer-readable storage medium of claim 10, wherein identifying within the different object sources, objects for publication within the NOV report comprises determining objects within the different object sources using data from a common data source.

12. The computer-readable storage medium of claim 10, wherein determining the different object sources to access that are used in generating the NOV report comprises determining object sources that are returned as a result of a search of objects.

13. The computer-readable storage medium of claim 10, wherein determining the different object sources to access that are used in generating the NOV report comprises determining at least one data store to scan for object sources of a specific type.

14. The computer-readable storage medium of claim 10, further comprising determining when an object within the rendered NOV report is edited and creating a copy of the object and storing the copy of the object in an object source that is associated with a user editing the object.

15. The computer-readable storage medium of claim 10, wherein identifying within the different object sources, objects for publication to the NOV report comprises enforcing access rights that are associated with each of the different object sources, wherein the access right is one of: a view access right, a no access right, a read access right, a write access right, and an edit access right.

16. The computer-readable storage medium of claim 10, further comprising determining when an object is selected within the rendered report and in response to the selection displaying an object source that includes the selected object.

17. A system for generating a named object view report from multiple object sources, comprising:
a network connection that is configured to connect to a network;
a processor, memory, and a computer-readable storage medium;
an operating environment stored on the computer-readable storage medium and executing on the processor;
a NOV manager configured to perform actions, comprising:
receiving a request to generate a named object view NOV report;
determining different object sources to access that are used in generating the NOV report, wherein the different object sources comprise spreadsheet objects;
enforcing access rights that are associated with each of the different object sources,
identifying within the different object sources objects for publication to the NOV report;
excluding objects from publication in the NOV report that are not identified from the different object sources;
generating the NOV report comprising the identified objects for publication; and
rendering the NOV report such that the identified objects for publication are editable.

18. The system of claim 17, wherein identifying within the different object sources objects for publication within the NOV report comprises determining objects within the different object sources using data from a common data source.

19. The system of claim 17, wherein determining the different object sources to access that are used in generating the NOV report comprises determining object sources that are returned as a result of a search of objects.

20. The system of claim 17, further comprising determining when an object within the rendered NOV report is edited and creating a copy of the object and storing the copy of the object in an object source that is associated with a user editing the object.
